(19) United States
(12) Patent Application Publication
(10) Pub. No.: US 2013/0126046 A1
(43) Pub. Date: May 23, 2013

(54) Tree pruning method and tree pruning head for performing same.

(71) Applicant: Jean-Paul Larouche, Mirabel (CA)

(72) Inventor: Jean-Paul Larouche, Mirabel (CA)

(21) Appl. No.: 13/585,997

(22) Filed: Aug. 15, 2012

(30) Foreign Application Priority Data
Nov. 21, 2011 (GB) 1120043.3

(51) Int. Cl. A01G 23/095; B27L 1/00

(52) U.S. Cl. 144/343; 144/24.13

(57) ABSTRACT

A method for cutting a branch from a tree using a blade, the branch extending outwardly from a main tree portion, the method comprising: positioning the blade substantially adjacent to the branch and substantially perpendicular thereto; and moving the blade transversely across the branch to cut the branch. Moving the blade transversely across the branch includes moving the blade along a curved path, the curved path being concave in a direction facing the main tree portion. Also, a tree pruning head for performing the method.

The present application claims priority from UK Request Application Serial Number 1120043.3 filed on Nov. 21, 2011, the contents of which is hereby incorporated by reference in its entirety.

### FIELD OF THE INVENTION

The present invention relates generally to the field of tree cutting, and, more particularly, to a tree pruning method and a tree pruning head for performing the same.

### BACKGROUND

The prior art proposes numerous power operated devices that offer means for executing operations such as pruning or cutting branches off the trunk or the major limbs of a tree. These devices typically comprise at least one cutting means, such as a scissor or shear-type cutter, a power chain saw, a round saw or a band saw mechanism.

In some instances, prior art devices may also include at least one means for stably gripping a portion of the tree that is substantially adjacent where the cutting or pruning operation is executed such as, for example, a tree branch destined to be cut and removed.

The cutting and gripping means of these devices are generally articulated by hydraulic cylinders, hydraulic motors and/or electric motors.

Typically, these devices of the prior art are attached to the distal end of a carrier boom mounted on a self-powered vehicle, and are hydraulically and/or electrically powered by suitable power generating sub-systems mounted on the vehicle.

A power operated device of the prior art thus equipped with a cutting means and a gripping means, and attached to the distal end of a carrier boom mounted on a self-powered vehicle, allows an operator of the vehicle to remotely grip and cut a branch, then manipulate the latter to a desired location.

The thus pruned trees using these devices are generally destined for wood harvesting in tree nurseries, or general aesthetical objectives in public parks and the like.

While these prior art devices can generally fulfill the main objective of pruning and cutting trees, they are generally inefficient in executing a properly executed cut face on the remaining branch stumps of pruned trees.

Indeed, these devices of the prior art generally sever a branch without conditioning the cut face such that the remaining branch stump displays a substantially straight cut face in which the distal ends of wood fibers, which have been generally violently cut, are left protruding in a substantially frayed manner.

This state of cut face is generally undesirable since it leaves a pruned tree substantially vulnerable to biological infections and diseases, promoted in part by some insects, mildew and the likes. The end result is a tree that takes more time to heal, if it heals at all in some instances, and generally greatly affects the quality, and thus, the value, of the wood destined to be harvested, or the aesthetical qualities of tree as it grows along the years.

Against this background, there exist a need for an improved tree pruning method and an improved tree pruning head. An object of this invention is to provide such a method and such a tree pruning head.

### SUMMARY OF THE INVENTION

In a broad aspect, the invention provides a tree pruning head for cutting a branch from a tree, a branch stump defining a free end surface extending from the tree after the branch has been cut, the tree pruning head comprising: a body, the body defining an abutment surface for abutting against the tree; a cutting element mounted to the body and movable relative thereto, the cutting element defining a cutting edge movable across the branch to cut the branch; a guiding element for guiding a movement of the cutting element such that the cutting edge moves along a predetermined path relative to the abutment surface; and a cutting element actuator operatively coupled to the cutting element for selectively moving the cutting element so that the cutting edge is moved along the predetermined path. The predetermined path is curved relative to the body in a plane perpendicular to the cutting edge and is concave in a direction facing towards the abutment surface. Cutting the branch with the cutting element with the abutment surface abutting against the tree adjacent the branch creates the branch stump, the branch stump having a predetermined length and the free end surface being convex.

In some embodiments of the invention, the tree pruning head further comprises a gripping element mounted to the body for gripping the branch, the gripping element being movable between an open configuration and a gripping configuration, wherein, in the open configuration, the gripping element is movable relative to the branch, and, in the gripping configuration, the gripping element is able to grip the branch so as to immobilize the body relative to the branch; and a gripping element actuator operatively coupled to the gripping element for selectively moving the gripping element between the gripping and open configurations.

In some embodiments of the invention, the cutting element is provided between the abutment surface and the gripping element.

In some embodiments of the invention, the gripping element includes a pair of gripping pads movable relative to the body by the gripping element actuator for selectively gripping the branch therebetween, the gripping pads being spaced apart from each other by a greater distance in the open configuration than in the gripping configuration.

In some embodiments of the invention, the body defines an abutment cradle, the abutment surface being defined by the abutment cradle, the abutment surface being concave. In some embodiments of the invention, the abutment cradle defines a cradle back surface opposed to the abutment surface, an edge peripherally located relative to the abutment and cradle back surfaces and a recess for receiving the branch thereinto when the abutment surface abuts against the tree, the recess extending inwardly from the edge and between the abutment and cradle back surfaces, at least part of the cutting edge moving in register with the recess when the cutting edge moves along the predetermined path. For example, the recess has a shape selected from the group consisting of a U-shape, a V-shape and a U-shape with flared free ends.

In some embodiments of the invention, the guiding element includes a pair of guiding rails facing each other and supporting the cutting element therebetween, the cutting element being slidable along the guiding rails.

In some embodiments of the invention, the cutting element actuator includes a longitudinally extensible actuator pivotally mounted at longitudinally opposite ends thereof to the cutting element and to the body.

In some embodiments of the invention, the cutting element includes a blade, the blade being curved plate-shaped. In some specific embodiments of the invention, the cutting element includes a pair of blades each defining a respective substantially elongated blade cutting edge, the blade cutting edges of the blades facing each other, the blades being movable in a reciprocating movement relative to each other to vary a distance between the blade cutting edges, the blades being movable between a blade closest configuration in which the blades are at a minimal distance from each other and a blade farthest configuration in which the blades are at a maximal distance from each other. In a variant, the blades overlap each other adjacent the blade cutting edges in the blade closest configuration.

In some embodiments of the invention, the body defines an abutment cradle, the abutment surface being concave and defined by the abutment cradle, the abutment cradle also defining a blade guiding surface opposed to the abutment surface, the blades conforming to the shape of the blade guiding surface.

In some embodiments of the invention, the tree pruning head further comprises a shim plate selectively insertable between at least one of the blades and the abutment cradle

In some embodiments of the invention, the cutting element actuator includes a blade distance adjuster to selectively adjust a distance between the blades when the blades are in the blade closest configuration.

In some embodiments of the invention, the tree pruning head further comprises an attachment pivotably attached to the body and attachable to a carrier boom.

In another broad aspect, the invention provides a method for cutting a branch from a tree using a blade, the branch extending outwardly from a main tree portion, the method comprising: positioning the blade substantially adjacent to the branch and substantially perpendicular thereto; and moving the blade transversely across the branch to cut the branch. Wherein moving the blade transversely across the branch includes moving the blade along a curved path, the curved path being concave in a direction facing the main tree portion. In some embodiments of the invention, positioning the blade includes positioning the blade at a predetermined distance from the main tree portion along the branch.

The tree pruning head is typically usable for remotely executing pruning operations on a tree during which a branch is cut while the cut face of the remaining branch stump is simultaneously conditioned for an optimized healing.

Pruning operations using the tree pruning head may be executed, for examples, on branches extending from the trunk and/or from user selected branches of a tree. Pruning operations may also encompass operations such as, for examples, trimming and topping operations of trees.

In some instances, the tree pruning head may further be usable for directly cutting the trunk of trees such as, for examples, the trunk of relatively small bush-type trees during land clearing or thinning operations.

The particular configuration, disposition and arrangement of the cutting element, in cooperative relation with the abutment cradle usable for selectively stably abutting the tree pruning head against the trunk of a tree represent an advantageous aspect of the tree pruning head, according to the present invention. The advantage resides in that the tree pruning head provides a means for efficiently and rapidly pruning a branch in which the branch is simultaneously cut at a user selected distance from the trunk, and the cut face of the remaining branch stump is conditioned in a substantially rounded end, which significantly enhance and optimize the conditions for a successful healing process of the tree, in order to obtain the highest quality of trees for wood harvesting or general aesthetical aspects.

Typically, the components of the various embodiments of a tree pruning head, which will be described in the appended detailed description, are configured, shaped and sized, as well as being made of sufficiently rigid materials, for substantially efficiently executing pruning operations on a predefined diameter and rigidity of branches to be cut and conditioned during a given pruning operation on trees.

For examples, the various components of a tree pruning head of the present invention may be made of a material, or a combination of materials, such as steel, aluminum, a polymeric material, a carbon fiber based composite material, among others.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a front perspective view, illustrates a tree pruning head according to an embodiment of the present invention;

FIG. 2, in a rear perspective view, illustrates the tree pruning head shown in FIG. 1, here shown with a pivotable attachment thereof pivotally extended on one side;

FIG. 3, in a rear perspective view, illustrates the tree pruning head shown in FIGS. 1 and 2, here shown with the pivotable attachment centered;

FIG. 4, in a top plan, cross-sectional view, illustrates the tree pruning head shown in FIGS. 1 to 3, taken along section line IV seen in FIG. 3;

FIGS. 5, 6 and 7, in a top plan view, illustrate a body part of the tree pruning head shown in FIGS. 1 to 4 in a left, centered and right orientation respectively, relative to the general longitudinal axis of the pivotable attachment;

FIG. 8, in a top plan view, illustrates the tree pruning head shown in FIGS. 1 to 7, here shown abutting against a longitudinal side portion of the trunk of a tree and engaging a branch, with the branch being shown firmly grasped between a pair of gripping arm assemblies part of the tree pruning head;

FIG. 9, in a top plan, partial view, illustrates the base of the branch engaged in a recess provided along a top edge portion of an abutment cradle part of the tree pruning head shown in FIGS. 1 to 8;

FIGS. 10, 11 and 12, in front partial views, illustrate various shape configurations of the recess;

FIGS. 13A and 13B, in a top partial view and a rear partial view respectively, illustrate the pair of cutting arm assemblies in an open configuration;

FIG. 14A and 14B, in a top partial view and a rear partial view respectively, illustrates the pair of cutting arm assemblies shown in FIGS. 13A and 13B in a closed configuration;

FIGS. 15 and 16, in a rear partial view, illustrates various configurations of blade edges of a pair of blades part of the tree pruning head shown in FIGS. 1 to 9, here shown in a closed configuration;

FIG. 17, in top partial view, illustrates an alternative embodiment of the pair of blades, here shown in a closed configuration, in which the blades have overlapping distal blade edge portions;

FIG. 18, in a top plan, environmental view, illustrates the tree pruning head shown in FIGS.1 to 9 in operation at the distal end of a carrier boom mounted on a self-powered vehicle; and

FIG. 19, in a top plan, partial view, illustrates a branch stump after a branch has been cut by the tree pruning head shown in FIGS. 1 to 9.

### DETAILED DESCRIPTION

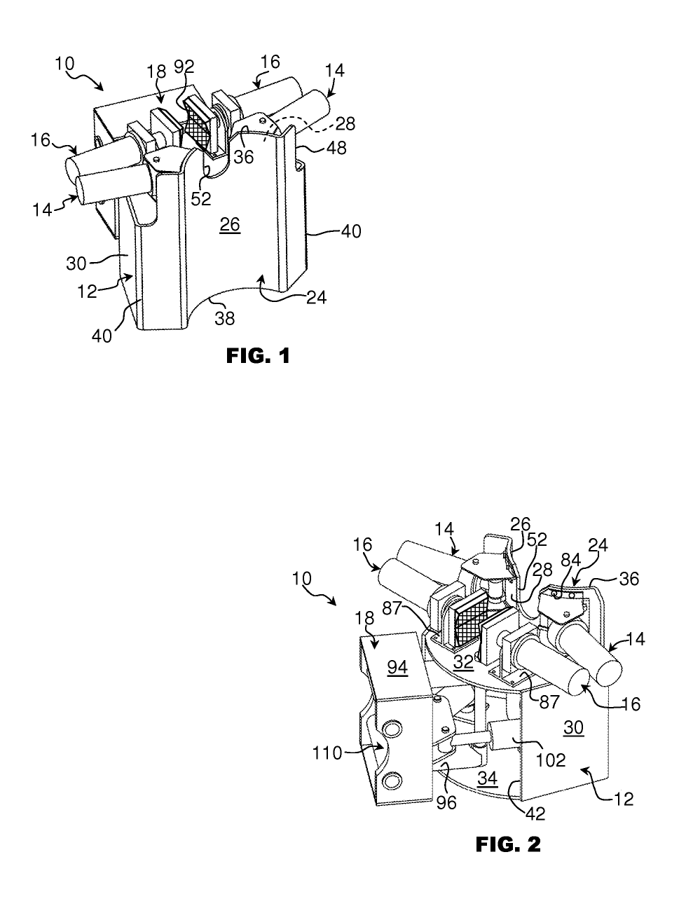

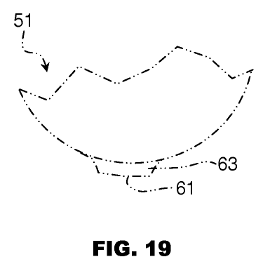

FIGS. 1 and 2 illustrate an embodiment of a tree pruning head 10 according to an embodiment of the present invention. As better illustrated in FIGS. 8, 9 and 19, The tree pruning head 10 is typically usable for remotely executing pruning operations on a tree 51 during which a branch 60 is cut while the free end surface 61 (seen only in FIG. 19) of the remaining branch stump 63 (seen only in FIG. 19) is simultaneously conditioned for an optimized healing.

Pruning operations using the tree pruning head 10 may be executed, for examples, on branches 60 extending from the trunk 50 and/or from user selected branches 60 of a tree 51. Pruning operations may also encompass operations such as, for examples, trimming and topping operations of trees 51.

In some instances, the tree pruning head 10 may further be usable for directly cutting the trunk 50 of trees 51 such as, for examples, the trunk 50 of relatively small bush-type trees 51 during land clearing or thinning operations.

It is to be noted that, while the terminology ‘trunk’ is used throughout this specification to generally designate the trunk 50 of a tree 51, the reader skilled in the art will readily understand that the terminology ‘trunk’ may also be used to designate, for example, the trunk of a branch 60 in a tree 51 having a predefined minimum diameter selected by an operator of the tree pruning head 10.

Typically, the components of the various embodiments of a tree pruning head 10, which will be described hereinafter, are configured, shaped and sized, as well as being made of sufficiently rigid materials, for substantially efficiently executing pruning operations on a predefined maximum diameter and rigidity of branches 60 to be cut and conditioned during a given pruning operation.

For examples, the various components of a tree pruning head 10 of the present invention may be made of a material, or a combination of materials, such as steel, aluminum, a polymeric material, a carbon fiber based composite material, among others.

Furthermore, all pivotable joints described in the following description typically include sealed roller ball bearing elements, or equivalent, for long lasting, frictionless operation. In addition, directional terminology such as top, bottom, rear and front is used in the present document to facilitate comprehension and refers to the tree pruning head 10 in a typical orientation in use when abutting against a generally vertical trunk 50. This terminology should not be used to limit the scope of the present invention as in some embodiments, the tree pruning head 10 is usable in different orientations.

The longitudinally extensible actuators referred to in the following description may of the double acting or spring return type. Furthermore, these longitudinally extensible actuators may be represented by hydraulic cylinders, air pressure cylinders, electrically powered actuators, or a combination of these. Electrically powered actuators may be represented, for examples, by solenoid actuators, motor and endless screw combinations, linear motors, or the likes. Typically, the longitudinally extensible actuators are double acting hydraulic cylinders.

Referring to FIG. 1, the tree pruning head 10 generally comprises a body 12 and, mounted on selected portions of the body 12, at least one, and typically a pair, of power operated cutting arm assemblies 14, a pair of power operated gripper arm assemblies 16 and a power operated, pivotable attachment 18 respectively.

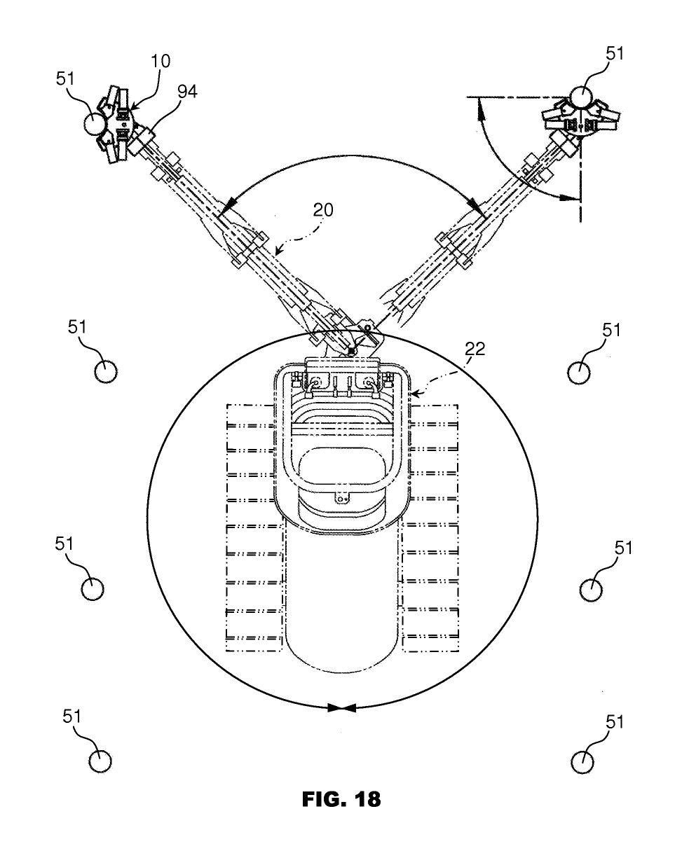

The body 12, additionally to providing a main support structure for the other components of the tree pruning head 10, provides a structure usable for selectively stably abutting the tree pruning head 10 against, for example, the trunk 50 of a tree 51 to be pruned. To that effect, the body 12 defines an abutment surface 26 for abutting against the tree 51. The pair of power operated cutting arm assemblies 14 are selectively usable for simultaneously cutting branches 60 and conditioning branch stumps 63 on trees 51. The pair of power operated gripping arm assemblies 16 are usable for selectively gripping a portion of a branch 60 or trunk 50 destined to be cut. The power operated, pivotable attachment 18 is usable for operatively attaching the tree pruning head 10 typically to the distal end of a carrier boom 20 mounted on a self-powered vehicle 22, or the like, as illustrated in FIG. 18.

It is to be noted that all rigid and flexible hydraulic conduits and electrical wirings that may be required for powering and controlling the power operated elements of the tree pruning head 10, as described above, are of the conventional types and have been omitted from the present detailed description and appended drawings for clarity.

Referring to FIG. 1, the body 12 is typically represented by a substantially hollow housing defining an abutment cradle 24, the abutment cradle 24 defining the abutment surface 26, and an opposed blade guiding surface 28. As better seen in FIG. 2, extending substantially distally from, and integrally joined with, the blade guiding surface 28, are a pair of substantially oppositely disposed side walls 30 and substantially oppositely disposed top and bottom walls 32 and 34. Thus, distal rear edges of the side, top and bottom walls 30, 32 and 34 respectively, cooperatively represent a rear portion of the body 12, and form the edge of an aperture of a cavity 42 extending substantially inwardly towards the blade guiding surface 28.

As better seen in FIG. 1, the abutment cradle 24 is preferably represented by a substantially cradle-like shaped plate member having a substantially rectangular overall configuration and defining a concave abutment surface 26. The abutment cradle 24 generally defines oppositely disposed top and bottom edges 36 and 38, and a pair of substantially parallel longitudinal side edges 40 respectively, as best illustrated in FIG. 1.

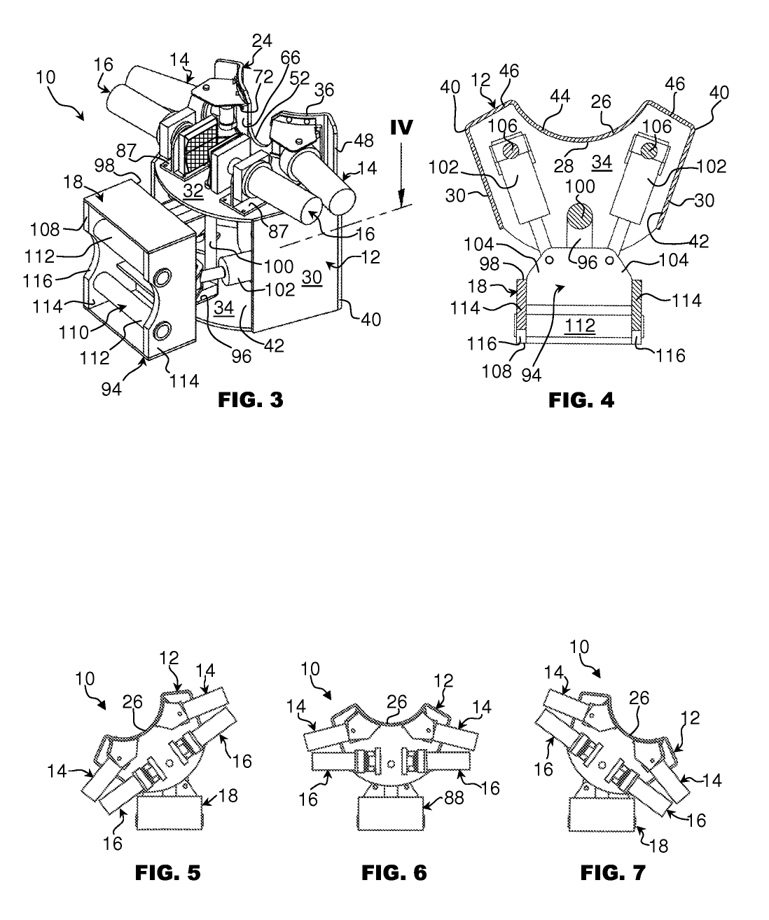

As seen for example in FIG. 4, the abutment cradle 24 further defines a cross-section, taken along a substantially median horizontal line between the top and bottom edges 36 and 38 respectively, that is having a substantially centered and semi-circular portion 44. The semi-circular portion 44 is preferably extended at each distal end thereof with a pair of relatively smaller and substantially rectilinear portions 46. The rectilinear portions 46 are preferably extending at least slightly rearwardly at a predetermined angle, relative to a general transverse axis of the abutment cradle 24, to join, at a distal end thereof, with a proximal inner edge of the corresponding side wall 30.

It is to be noted that the abutment cradle 24 and side walls 30 may be advantageously formed out of a single plate member using a conventional punch-press process.

Furthermore, as can be observed in the drawings, the substantially front to rear taper-like configuration of the body 12 substantially minimizes the overall size of the tree pruning head 10, which significantly increases its ease of manipulation through branches 60 of a tree 51, as well as enhancing the overall structural strength of the body 12. Also, while the body 12 described herein has to been found to be well suited for its purpose, other body shapes are within the scope of the present invention.

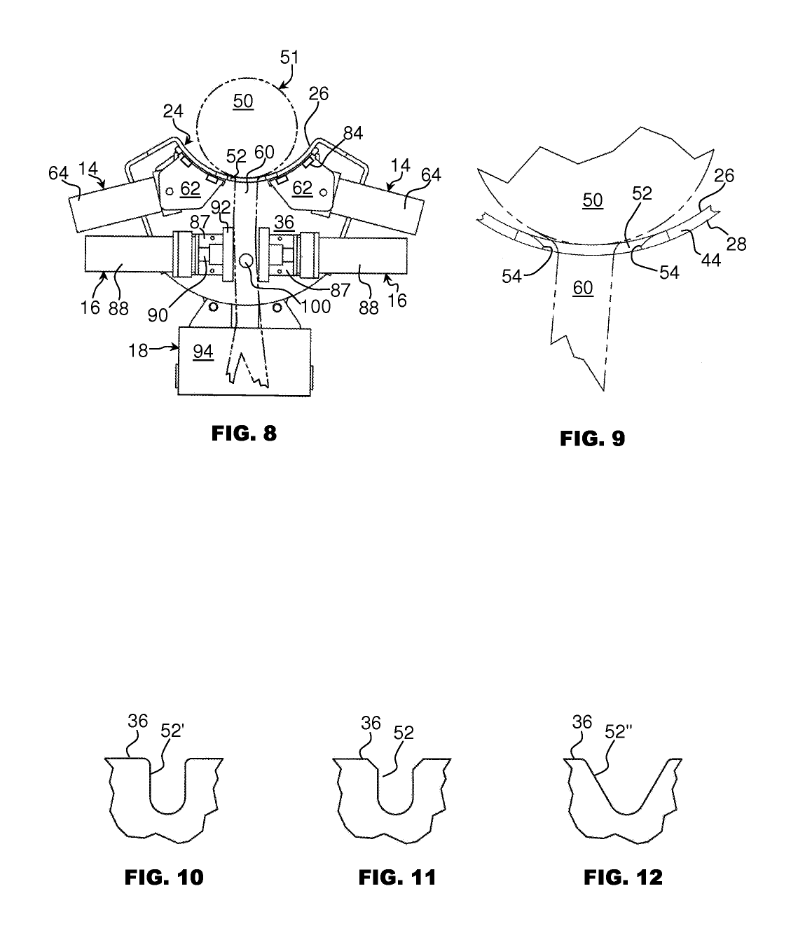

Typically, the outer surface of the semi-circular portion 44 of the abutment cradle 24 is typically usable for stably abutting the tree pruning head 10 against the trunk 50 of a tree 51 to be pruned, as best illustrated in FIGS. 8 and 9.

Furthermore, the abutment cradle 24 extends a predefined length substantially perpendicularly distally relative to the top surface of the top wall 32 to form an abutment cradle top portion 48 (seen for example in FIG. 3). The abutment cradle top portion 48 is configured, shaped and sized for suitably supporting the pair of cutter arm assemblies 14, which will be described further below.

The abutment cradle 24 defines a cradle back surface, referred to herein as the blade guiding surface 28, opposed to the abutment surface 26, an edge, for example the top edge 36, peripherally located relative to the abutment and blade guiding surfaces 26 and 28, and a recess 52 for receiving the branch 60 thereinto when the abutment surface 26 abuts against the tree 51. The recess extends inwardly from the top edge 36 and between the abutment and blade guiding surfaces 26 and 28, at least part of the cutting edge 76 moving in register with the recess 52 when the cutting edge 76 moves along the predetermined path. In a typical embodiment, the recess 52 is substantially centered along the top edge 36 and U-shaped. Typically, the recess 52 is usable for engaging the base portion of a branch 60 substantially at the junction with the trunk 50 of a tree 51, as best illustrated in FIG. 8, or at the junction with a relatively larger supporting branch 60.

For example, a common size of recess 52 may be suitably sized for pruning branches 60 having up to 2.75″ in diameter. As would be evident to one skilled in the art, other sizes of recess 52 and, consequently, of a proportionally sized tree pruning head 10, may allow the latter to prune relatively smaller or larger diameters of branches 60 and/or trunks 50 of trees 51.

Although the recess 52 is exemplified in drawings as having a substantially U-shaped configuration with flared free ends, as best illustrated in FIGS. 1 and 11, it is to be understood that other relatively equivalent shapes of a recess are also possible. For examples, the recess 52 may have a substantially conventional U-shaped configuration, as in recess 52′ illustrated in FIG. 10, or a relatively more flared, or V-shaped configuration, as in recess 52″ illustrated in FIG. 12.

In some embodiments of the invention, the recess 52 provides a substantially rounded beveled edge 54 tapering in a direction leading towards the blade guiding surface 28, as best illustrated in FIG. 9. The substantially rounded beveled edge 54 is for substantially conforming with, and also minimize damage to, the generally tapered base portion of a branch 60 and the proximal surface of the trunk 50 surrounding the latter.

The slightly flared recess 52 in cooperative relation with the substantially rounded beveled edge 54 significantly optimize and facilitate the alignment and engaging procedure of the recess 52 with the base portion of a branch 60 to be cut, as well as offering better abutment stability of the abutment cradle 24 against the adjacent surface of the trunk 50, for a substantially precise and well executed pruning operation. The pruning operation referred to in the above text will be described in details further below, along with a preferred method of operation of the tree pruning head 10.

As it will be described in more details hereinafter, along with a detailed description of the pair of cutting arm assemblies 14, the thickness of the abutment cradle 24 adjacent the U-shaped recess 52 is of a predefined value which substantially determines the distance where a cut will be executed along the base portion of a branch 60, relative to the junction of the latter with the surrounding surface of the trunk 50 thereof.

Now referring more particularly to FIGS. 2, 8, 13A, 13B, 14A and 14B, the pair of cutting arm assemblies 14 are rigidly attached to rear surface portions of the abutment cradle 24, and substantially proximally on each side of the 52.

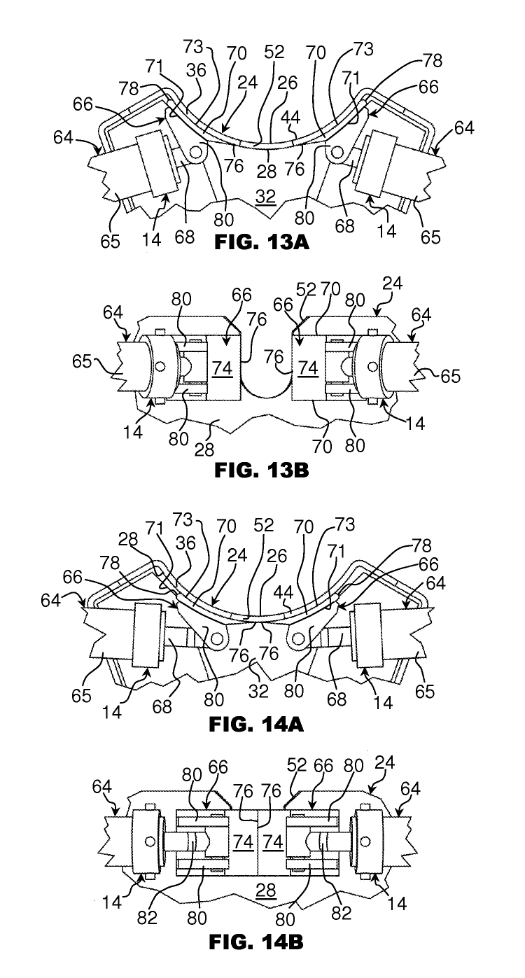

Referring to FIGS. 13B and 14B, each cutting arm assembly 14 generally includes a cutting element 66 mounted to the body 12 and movable relative thereto and a cutting element actuator 64. The cutting element 66 defines a cutting edge 76 movable across the branch 60 to cut the branch 60. A guiding element 72, better seen in FIG. 2, is provided for guiding a movement of the cutting element 66 such that the cutting edge 76 moves along a predetermined path relative to the abutment surface 26. The cutting element actuator 64 is operatively coupled to the cutting element 66 for selectively moving the cutting element 66 so that the cutting edge 76 is moved along the predetermined path. At least part of the cutting edge 76 moves in register with the recess 52 when the cutting edge 76 moves along the predetermined path.

The predetermined path is curved relative to the body 12 in a plane perpendicular to the cutting edge 76 and is concave in a direction facing towards the abutment surface 26. Therefore, cutting the branch 60 with the cutting element 66 with the abutment surface 26 abutting against the tree 51 adjacent the branch 60 creates the branch stump 63, as seen in FIG. 19, the branch stump 63 having a predetermined length and the free end surface 61 being convex.

Referring to FIG. 8, in a typical example, the cutting element actuator 64 includes a longitudinally extensible actuator 64 pivotally mounted at longitudinally opposite ends thereof to the cutting element 66 and to the body 12. For example, the body 12 defines a pair of pivot support members 62, one for each cutting arm assembly 14, attached to the abutment cradle 24. Also, the cutting element actuator 64 is a double acting, longitudinally extensible actuator including an actuating portion 65 and a substantially elongated actuator rod 68 longitudinally movable relative to the actuating portion 65, as seen in FIGS. 13A and 13B. The actuating portion 65 is pivotally mounted, along a transversal axis, to the pivot support members 62. The actuator rod 68 is pivotally mounted along a transversal axis, at the distal end thereof, to the cutting element 66. Typically, the actuating portion 65 is pivotally mounted on the pivot support members 62 along a transversal axis that is located substantially proximal the distal end of the body 12 that is adjacent the blade element 66, as best illustrated in FIG. 8. However, other configurations for the cutting element actuator 64 are within the scope of the present invention.

As seen in FIGS. 13A and 14A, the cutting element 66 typically includes a blade 74 having a substantially square or rectangular overall configuration when observed in a top plan view, as best illustrated in FIG. 13B. The blade 74 generally defines a substantially acute and elongated blade cutting edge 76, which forms the cutting edge 76 of the cutting element 66, a pair of substantially parallel longitudinal side edges 70 and a rear edge 78. The blade 74 further defines a substantially convex upperside surface 71, a substantially concave underside surface 73 and a substantially arched configuration when observed in a longitudinal side cross-section view, as best illustrated in FIG. 13A. In other words, the blade 74 is curved plate-shaped.

When two cutting elements 66 are present, the blade cutting edges 76 of the blades 74 face each other with the blades 74 being movable in a reciprocating movement relative to each other to vary a distance between the blade cutting edges 76. The blades 74 are movable between a blade closest configuration, seen for example in FIGS. 14A and 14B, in which the blades 74 are at a minimal distance from each other, and a blade farthest configuration, seen for example in FIGS. 13A and 13B, in which the blades 74 are at a maximal distance from each other.

In this example, the guiding elements 72 takes the form of a pair of guiding rails 72 facing each other and supporting the cutting element 66 therebetween, only one of which is clearly visible in FIG. 3, the cutting element 66 being slidable along the guiding rails 72. More specifically, the longitudinal side edges 70 are suitably configured, sized and shaped for freely slidably engage in guiding rails 72 extending oppositely inwardly along oppositely facing inner surface portions of the pivot support members 62, and extending substantially proximally along the junction of the latters with the blade guiding surface 28.

The substantially concave underside surface 73 of the blade element 66 substantially conforms to the substantially arched configuration of the blade guiding surface 28. Furthermore, a pair of pivot support members 80 are extending distally from the upperside surface 71 of the blade 74 and preferably along the oppositely disposed longitudinal side edge 70 thereof, for pivotally mounting the cutting element 66 at the distal end of the actuator rod 68.

As would be evident to one skilled in the art, at least the cutting edge 76 of the cutting element 66 is preferably made of suitably hardened steel for a long lasting operation.

When the cutting element actuators 64 are actuated, the oppositely facing blade elements 66 move reciprocally along a substantially arched path that conform, in a substantially proximally parallel configuration, to the blade guiding surface 28.

Thus, the cutting element actuators 64 of the cutting arm assemblies 14 may be actuated between a retracted configuration, in which the blade elements 66 are substantially spaced apart, as in the furthest configuration, and with their distal cutting edge 76 preferably substantially clear of the U-shaped recess 52, as illustrated in FIGS. 13 A and 13B, and an extended configuration, in which the cutting elements 66 have their cutting edges 76 substantially abutting against one another, as in the closest configuration and as illustrated in FIGS. 14A and 14B.

Furthermore, the relative distance between the oppositely facing cutting arm assemblies 14 is such that, when both actuator rods 68 are fully extended, the blade cutting edges 76 of the oppositely facing cutting elements 66 typically at least slightly abut against one another to perform a substantially complete transversal cut through a portion of a branch 60 longitudinally extending therebetween. The thus abutting cutting edges 76 of the blades 74 coincide preferably at least roughly at the center of the branch 60 for a substantially uniformly rounded cut face of the branch stump 63.

Typically, the cutting element actuator 64 includes a blade distance adjuster 82, seen in FIG. 14A, to selectively adjust a distance between the blades 74 when the blades 74 are closest to each other. To that effect, in an example, the actuator rods 68 are provided with a blade distance adjuster 82 positioned substantially proximal the distal end thereof for selectively adjusting the length of the actuator rod 68. Thus, when the cutting edges 76 do not at least slightly abut against one another when the actuator rods 68 are fully extended, for example such as when the cutting edge 76 have been worn out, a maintenance personnel may selectively adjust the length of one or both actuator rods 68 such that the oppositely facing cutting edges 76 do at least slightly abut against one another. For example, a blade distance adjuster 82 may be represented by an internally threaded sleeve engaged on adjacent and oppositely facing threaded ends of a two-section actuator rod 68, or equivalent.

Alternatively, or in combination with, the blade distance adjuster 82 described above, the blade distance adjuster 82 may be represented by conventional screw-type adjustment elements with guiding elements (not shown in the drawings) provided between the base of the pair of pivot support members 62 and the blade guiding surface 28, for selectively adjusting the position of a cutting arm assembly 14 relative to the blade guiding surface 28 and the oppositely facing cutting arm assembly 14.

In some embodiments of the invention, the pivot support members 62 are releasably mounted on the blade guiding surface 28 using, for example, conventional releasable attachments 84 such as screw and bolt combinations, or equivalent, as illustrated in FIG. 8. Thus, the releasable attachments 84 may be selectively at least slightly loosened, or even fully removed, for allowing the insertion between the pivot support members 62 and the blade guiding surface 28, of one or more suitably configured, shaped and sized shim plate, such as the shim plate 86, as illustrated in FIG. 17. In these embodiments, the shim plate 86 is selectively insertable between at least one of the blades 74 and the abutment cradle 24.

Thus, at least one, but typically both cutting arm assemblies 14 may be selectively shimmed such that the cutting edges 76 substantially initiate a transversal cut through the base of a branch 60 to be pruned at a user selected distance relative to the abutment surface 26 which, in turn, substantially determines the user selected length of the protruding branch stump 63 remaining on a tree 51 after a pruning operation.

The particular configuration, disposition and arrangement of the cutting arm assemblies 14, in cooperative relation with the shim plates 86, the semi-circular portion 44 of the abutment cradle 24 and the U-shaped recess 52, represent an advantageous aspect of the tree pruning head 10. The advantage resides in that the tree pruning head 10 provides a means for pruning a branch 60 in which the branch 60 is simultaneously cut at a user selected distance from the trunk 50, and the free end surface 61 of the remaining branch stump 63, conditioned in a substantially rounded end, which significantly enhances and optimizes the conditions for a successful healing process of the tree 51.

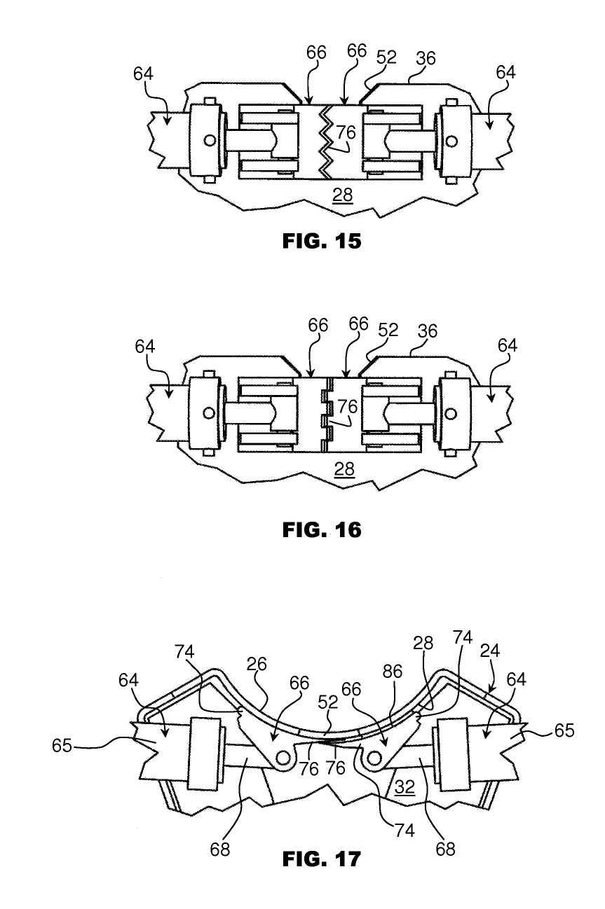

The cutting edges 76 of the cutting elements 66 are typically rectilinear, as best illustrated in FIG. 13B. But, as would be evident to one skilled in the art, it is to be understood that other configurations of cutting edges 76 are also possible. For examples, the cutting edges 76 may have a substantially saw-tooth shaped configuration, as illustrated in FIG. 15, a substantially square-tooth shaped configuration, as illustrated in FIG. 16, among other possibilities.

Now referring more particularly to FIGS. 1, 2, and 8, the pair of power operated gripping arm assemblies 16 together form an example of a gripping element 92/gripping element actuator 88 assembly mounted to the body 12 for gripping the branch 60. Each gripping element 92 is movable between an open configuration, seen for example in FIG. 3, and a gripping configuration, seen for example in FIG. 8. In the open configuration, the gripping element 92 is movable relative to the branch 60, and, in the gripping configuration, the gripping element 92 is able to grip the branch 60 so as to immobilize the body 12 relative to the branch 60. Each gripping element actuator 88 is operatively coupled to a respective gripping element 92 for selectively moving the gripping element 92 between the gripping and open configurations. While a specific gripping element 92 and gripping element actuator 88 combination is described hereinbelow, any other suitable configuration of alternative suitable gripping element 92 and gripping element actuator 88 is within the scope of the present invention.

In the embodiment of the invention shown in the drawings, each gripping arm assembly 16 is rigidly attached the top wall 32 of the body 12 proximally on either side of a front to rear imaginary path in register with the recess 52 of the abutment cradle 24. Typically, the cutting element 66 is provided between the abutment surface 26 and the gripping element 92, so that the gripping element 92 grips the branch 60 at a location further away from the remainder of the tree 51 than the cutting element 66.

Each gripping arm assembly 16 generally comprises a gripping arm support member 87 rigidly fastened to the top wall 32 of the body 12, a double acting, longitudinally extensible gripping element actuator 88 mounted on the gripping arm support member 87 and the gripping element 92. The gripping element actuator includes a rod 90 longitudinally movable by the gripping element actuator 88 and the gripping element 92 is attached to the distal end of the rod 90. The pair of gripping arm assemblies 16 may selectively cooperatively engage and firmly grasp a portion of a branch 60 positioned therebetween. For example, the gripping elements 92 take the form of gripping pads 92 movable relative to the body 12 by the gripping element actuator 88 for selectively gripping the branch 60 therebetween, the gripping pads 92 being spaced apart from each other by a greater distance in the open configuration than in the gripping configuration.

Typically, the distal end surface of the gripping pads 92 is suitably shaped and configured for substantially firmly adhering to various shapes and surface textures of elongated portions of a branch 60 such as, for examples, a substantially rough or patterned surface, a resilient material such as rubber, or the likes, as illustrated in FIG. 1.

In typical use, the pair of gripping arm assemblies 16 may be advantageously used for gripping and stably holding in place a portion of a branch 60 destined to be cut, which may significantly facilitate the cutting operation and precision of the cut by the cutting arm assemblies 14. Once the branch 60 has been cut, the pair of gripping arm assemblies 16 may hold the thus severed branch 60 in order to prevent the latter from falling down to an undesired location. Finally, the pair of gripping arm assemblies 16 may hold the severed branch 60 while it is carried to a desired location where the gripping arm assemblies 16 may then release the branch 60.

Now referring more particularly to FIGS. 3 and 4, the pivotable attachment 18 is represented by an assembly generally comprising a substantially box-shaped attachment adapter 94, a pivot support member 96 projecting perpendicularly frontwardly from a substantially centered front end portion 98 of the attachment adapter 94, and having its distal end pivotally engaged about a substantially vertically disposed pivot pin member 100 extending between substantially centered inner surface portions of the top and bottom walls 32 and 34 of the body 12.

As best illustrated in FIG. 4, the power operated, pivotable attachment 18 further includes a pair of longitudinally extensible actuators 102, each of which having one distal end pivotally mounted, along a vertical axis, to oppositely disposed pivot support members 104 projecting substantially on each lateral side of the junction between the pivot support member 96 and the attachment adapter 94.

The opposite distal ends of the longitudinally extensible actuators 102 are pivotally mounted, along a vertical axis, to oppositely disposed pivot support members 106 positioned substantially proximally each oppositely disposed junction between the side walls 30 and the abutment cradle 24.

The configuration, size and position of the pivot pin member 100, the pivot support members 104 and 106, the actuators 102 and cavity 42 of the body 12, are such that the pivotable attachment 18 may be freely laterally pivotable roughly between forty (40) and fifty (50) degree on each side of a substantially central position. For example, the pivotable attachment 18 is freely laterally pivotable at least forty-five (45) degree on one side, relative to a substantially central position, as best illustrated in FIGS. 5, 6 and 7.

A rear end portion 108 of the attachment adapter 94 is provided with an industry standard quick release 110 for releasably coupling thereto a compatibly configured, shaped and sized distal end of a carrier boom 20. Such industry standard quick releases 110 are commonly found integrated, for example, along a rear end portion of earth excavating buckets and other equivalent earth excavation equipment that can be substantially quickly and remotely coupled to the distal end of the carrier boom of excavators and the likes.

As illustrated in FIG. 3, for example, such industry standard quick releases 110 may be represented, for example, by a pair of substantially spaced apart and parallelly disposed horizontal tubular members 112 rigidly attached between side walls 114 of the attachment adapter 94. The side walls 114 may further include semi-circular recesses 116 extending inwardly along rear edge portions thereof and substantially centered between the pair of tubular members 112.

As would be evident to one skilled in the art, other configurations of industry standard quick releases are also possible.

In some embodiments, a suitably configured, shaped and sized shim plate 86, having a predefined thickness, may be inserted and rigidly secured between the blade guiding surface 28 and only one of the power operated cutting arm assemblies 14, as illustrated in FIG. 17. Thus, the shim plate 86 provides a predefined offset distance between the abutment surface 26 and the corresponding blade 74, relative to the other blade element 66, such that the blade cutting edge 76 of one blade 74 is at least slightly overlapping the blade cutting edge 76 of the other blade 74 in a substantially scissor-like configuration. In other words, the blades 74 then overlap each other adjacent the blade cutting edges 76 in the blade closest configuration.

The overlapping configuration of the cutting edges 76 may be usable, for example, to simultaneously cut and at least slightly distance a branch 60 from the trunk 50 or supporting branch 60 of a tree 51. Furthermore, the overlapping configuration may advantageously require less maintenance since the oppositely facing cutting edges 76 of the cutting elements 66 do not need to be adjusted such that they substantially meet edge on edge together, as is the case with the first embodiment of a tree pruning head 10 described herein above.

Optionally, the cutting arm and/or gripping arm assemblies 14 and 16 respectively, may be protected with suitably configured, shaped and sized cover members (not shown) to reduce entanglement with branches 60 while reaching the location of a pruning operation on a tree 51.

A method of operating the tree pruning head 10 of the present invention will now be described. This method of operation performs a general method for cutting the branch 60 from the tree 51 using a blade 74, the branch 60 extending outwardly from a main tree portion, for example the trunk 50. However, in some embodiments, the main tree portion is a larger branch 60. The method includes positioning the blade 74 substantially adjacent to the branch 60 and substantially perpendicular thereto and moving the blade 74 transversely across the branch 60 to cut the branch 60. Moving the blade 74 transversely across the branch 60 includes moving the blade 74 along a curved path, the curved path being concave in a direction facing the main tree portion. Typically, positioning the blade 74 includes positioning the blade 74 at a predetermined distance from the main tree portion along the branch 60.

When the tree pruning head 10 is used, the following steps are followed, for example. The initial configuration is a tree pruning head 10 having its cutting and gripping arms assemblies 14 and 16 in an open configuration.

In a first step, the industry standard quick release 110 of the tree pruning head 10 is operatively coupled to the distal end of a carrier boom 20, including all necessary hydraulic, air and/or electrical connections required for the proper operation of the power operated actuators of the tree pruning head 10.

In a second step, the elongated semi-circular portion 44 of the abutment cradle 24 is longitudinally aligned with a longitudinal portion of, for example, the trunk of a tree 51, with the recess 52 substantially proximal the base of a branch 60 to be pruned, followed with abutting the abutment cradle 24 therealong.

In a third step, the tree pruning head 10 is moved such that the recess 52 is substantially firmly engaged about the base of the branch 60 to be pruned.

Alternatively, the second and third steps described above may be executed in a reverse order.

Optionally, in a fourth step, the gripping arm assemblies 16 are mutually closed together such that the branch 60 to be pruned is firmly grasped between the gripping element 92, which then achieves the gripping configuration.

In a fifth step, the cutting arm assemblies 14 are mutually closed together such that the base of the branch 60 to be pruned is simultaneously cut and conditioned at a predefined distance relative to the surrounding surface of the trunk 50 by bringing the cutting elements 66 to their closes configuration.

Optionally, in a sixth step, the body 12 of the tree pruning head 10 is pivoted laterally about its pivot pin member 100, and the carrier boom 20 at least slightly rotated laterally about its vertical pivot axis at its base on the vehicle 22, as well as vertically raised and lowered relative to the tree 51, for reaching another branch 60 to prune along a substantially ninety degree portion (90) around, for example, the trunk 50 of a tree 51, and extending substantially vertically therealong, as illustrated in FIG. 18.

In a seventh step, and in the case where the branch 60 was previously firmly grasped between the gripping arm assemblies in the fourth step above, the operator may carry the severed branch 60 to a desired location where the gripping arms are then opened to release the branch 60. Otherwise the tree pruning head 10 is moved towards the next branch 60 to be pruned.

In some instances, depending on the configuration and/or overall length of a branch 60 to be pruned, it might be required to, first, progressively cut the branch 60 into more easily manageable sections using the recess 52 in cooperative relation with the cutting arm assemblies 14 and, finally, cut and condition the last portion of the branch 60 at its junction with the trunk 50 of the tree 51.

In some other instances, in order to execute, for example, land clearing or thinning operations, the operator may substantially fully pivot the distal end of the carrier boom 20 such that the abutment cradle 24 of the tree pruning head 10 is substantially parallel with the ground surface, and proceed with cutting compatibly sized trunks 50 of bush-type trees 51 and the likes.

In yet some other instances, pruning operations may have to be executed through a large tree 51 nursery in which the trees 51 are distributed in a substantially uniformly spaced apart matrix configuration, such as illustrated in FIG. 18. In such a context, a substantially rapid and efficient method of pruning trees 51 generally consist in pruning corresponding ninety (90) degree longitudinal portions along vertical inner side portions of a pair of trees 51 in a row. This method generally only involves, additionally to the steps described above, a suitable rotation of the tree pruning head 10 in cooperative relation with a suitable rotation of the carrier boom 20, and/or the main body of the self-powered vehicle 22, without having to relocate the latter to complete portions of adjacent trees 51. Thus, each correspondingly facing one-hundred-eighty (180) degree portions of trees 51 between two rows of trees 51 may be substantially rapidly and efficiently accomplished.

In another embodiment of a tree pruning head (not shown in the drawings), according to the present invention, the tree pruning head is substantially identical to the first embodiment of a tree pruning head 10, as described above. The main difference resides in that the alternative tree pruning head does not include a pair of gripping arm assemblies 16. Furthermore, a preferred method of operation of the tree pruning head of this alternative embodiment is also substantially identical to the preferred method of operation of the first embodiment described above, except that it does not include steps for the operation of gripping arm assemblies 16.

Some advantages of the alternative tree pruning head reside in that the alternative tree pruning head may be advantageously manufactured at a lower cost. Furthermore, the tree pruning head of the present embodiment, having thus relatively less components than the first embodiment described above, is consequently relatively lighter and easier to manipulate at the distal end of a carrier boom. In some instance, the lighter tree pruning head of the present embodiment may require a relatively smaller and less expensive self-powered vehicle to operate than for the first embodiment described above.

Finally, the relatively light weight of the tree pruning head of the present embodiment may be appreciated for allowing the execution of relatively fast pruning operations of lower portions of the trunk 50 of trees 51, for example, in huge tree nurseries, where the branches 60 are not required to be gathered in specific locations around the work area immediately after they have been cut from the trees 51.

Although the present invention has been described hereinabove by way of preferred embodiments thereof, it can be modified, without departing from the spirit and nature of the subject invention as defined in the appended claims.

What is claimed is:

1. A tree pruning head for cutting a branch from a tree, a branch stump defining a free end surface extending from said tree after said branch has been cut, said tree pruning head comprising:
a body, said body defining an abutment surface for abutting against said tree;
a cutting element mounted to said body and movable relative thereto, said cutting element defining a cutting edge movable across said branch to cut said branch;
a guiding element for guiding a movement of said cutting element such that said cutting edge moves along a predetermined path relative to said abutment surface; and
a cutting element actuator operatively coupled to said cutting element for selectively moving said cutting element so that said cutting edge is moved along said predetermined path;
wherein said predetermined path is curved relative to said body in a plane perpendicular to said cutting edge and is concave in a direction facing towards said abutment surface;
whereby cutting said branch with said cutting element with said abutment surface abutting against said tree adjacent said branch creates said branch stump, said branch stump having a predetermined length and said free end surface being convex.

2. A tree pruning head as defined in claim 1, further comprising
a gripping element mounted to said body for gripping said branch, said gripping element being movable between an open configuration and a gripping configuration, wherein, in said open configuration, said gripping element is movable relative to said branch, and, in said gripping configuration, said gripping element is able to grip said branch so as to immobilize said body relative to said branch; and
a gripping element actuator operatively coupled to said gripping element for selectively moving said gripping element between said gripping and open configurations.

3. A tree pruning head as defined in claim 2, wherein said cutting element is provided between said abutment surface and said gripping element.

4. A tree pruning head as defined in claim 3, wherein said gripping element includes a pair of gripping pads movable relative to said body by said gripping element actuator for selectively gripping said branch therebetween, said gripping pads being spaced apart from each other by a greater distance in said open configuration than in said gripping configuration.

5. A tree pruning head as defined in claim 1, wherein said body defines an abutment cradle, said abutment surface being defined by said abutment cradle, said abutment surface being concave.

6. A tree pruning head as defined in claim 5, wherein said abutment cradle defines a cradle back surface opposed to said abutment surface, an edge peripherally located relative to said abutment and cradle back surfaces and a recess for receiving said branch thereinto when said abutment surface abuts against said tree, said recess extending inwardly from said edge and between said abutment and cradle back surfaces, at least part of said cutting edge moving in register with said recess when said cutting edge moves along said predetermined path.

7. A tree pruning head as defined in claim 6, wherein recess has a shape selected from the group consisting of a U-shape, a V-shape and a U-shape with flared free ends.

8. A tree pruning head as defined in claim 1, wherein said guiding element includes a pair of guiding rails facing each other and supporting said cutting element therebetween, said cutting element being slidable along said guiding rails.

9. A tree pruning head as defined in claim 1, wherein said cutting element actuator includes a longitudinally extensible actuator pivotally mounted at longitudinally opposite ends thereof to said cutting element and to said body.

10. A tree pruning head as defined in claim 1, wherein said cutting element includes a blade, said blade being curved plate-shaped.

11. A tree pruning head as defined in claim 1, wherein said cutting element includes a pair of blades each defining a respective substantially elongated blade cutting edge, said blade cutting edges of said blades facing each other, said blades being movable in a reciprocating movement relative to each other to vary a distance between said blade cutting edges, said blades being movable between a blade closest configuration in which said blades are at a minimal distance from each other and a blade farthest configuration in which said blades are at a maximal distance from each other.

12. A tree pruning head as defined in claim 11, wherein said blades overlap each other adjacent said blade cutting edges in said blade closest configuration.

13. A tree pruning head as defined in claim 11, wherein said body defines an abutment cradle, said abutment surface being concave and defined by said abutment cradle, said abutment cradle also defining a blade guiding surface opposed to said abutment surface, said blades conforming to the shape of said blade guiding surface.

14. A tree pruning head as defined in claim 13, further comprising a shim plate selectively insertable between at least one of said blades and said abutment cradle.

15. A tree pruning head as defined in claim 11, wherein said cutting element actuator includes a blade distance adjuster to selectively adjust a distance between said blades when said blades are in said blade closest configuration.

16. A tree pruning head as defined in claim 1, further comprising an attachment pivotably attached to said body and attachable to a carrier boom.

17. A method for cutting a branch from a tree using a blade, said branch extending outwardly from a main tree portion, said method comprising:
positioning said blade substantially adjacent to said branch and substantially perpendicular thereto; and
moving said blade transversely across said branch to cut said branch;
wherein moving said blade transversely across said branch includes moving said blade along a curved path, said curved path being concave in a direction facing said main tree portion.

18. A method as defined in claim 17, wherein positioning said blade includes positioning said blade at a predetermined distance from said main tree portion along said branch.
